(19) United States
(12) Patent Application Publication
(10) Pub. No.: US 2018/0197695 A1
(43) Pub. Date: Jul. 12, 2018

(54) ELECTRICAL SWITCHING CONTACT

(71) Applicant: SIEMENS AKTIENGESELLSCHAFT, München (DE)

(72) Inventors: Karl-Heinz Schaller, Ursensollen (DE); Heinz Speil, Amberg (DE); Heinz Wöllmer, Ammerthal (DE)

(21) Appl. No.: 15/741,858

(22) PCT Filed: May 19, 2016
(86) PCT No.: PCT/EP2016/061279

§ 371 Date: Jan. 4, 2018

(30) Foreign Application Priority Data
Jul. 7, 2015 (EP) 15175612.9

(51) Int. Cl. H01H 11/04; H01H 1/02; B22F 7/08

(52) U.S. Cl. CPC H01H 11/048; H01H 11/045; B22F 2301/255; B22F 7/08; H01H 2201/024; H01H 1/02

(57) ABSTRACT

The disclosure relates to an electrical switching contact, including a contact carrier and a contact plating, which has a contact material, and to a method for producing the electrical switching contact. The disclosure is characterized in that a layer that may be sintered is arranged between the contact material and the contact carrier in order to connect the contact material to the contact carrier.

The present patent document is a § 371 nationalization of PCT Application Serial Number PCT/EP2016/061279, filed May 19, 2016, designating the United States, which is hereby incorporated by reference, and this patent document also claims the benefit of EP 15175612.9, filed Jul. 7, 2015, which is also hereby incorporated by reference.

### TECHNICAL FIELD

The disclosure relates to an electrical switch contact including a contact base and a contact layer having a contact material, to a method of production thereof, and to a switch device including the electrical switch contact.

### BACKGROUND

Switch contacts include a contact base and at least one contact. The contact is subject to high demands with regard to the material characteristics. The demands include, for example, low transfer resistance and high arc erosion resistance. Contact base and contacts may be bonded by soldering, welding, riveting, screw connection, shrink fitting, or by combining these methods. A disadvantage here is the high complexity of manufacture for production of a complete switch contact. For example, for a double-break switch contact having two opposite contacts, five components have to be bonded to one another, entailing a high degree of complexity for avoidance of misplacement. It should likewise be taken into account that not all desired material combinations between contact base and contact may be welded and/or soldered.

Electrical contacts are used for opening and closing of circuits. In the case of contacts with high quality demands, (as employed, for example, in relays, contactors or high-power switches in low-voltage technology), the contacts include contact layers made of materials with a high silver content, which are bonded to base materials. For functional and manufacturing reasons, the contacts include a top layer of contact material, a pure silver layer that acts as a ductile buffer, a solder layer, and the base material.

The manufacture of contacts include the manufacture of the contact material, the application of the pure silver layer, the application of a solder layer, and the soldering of the contact layers onto the base. The pure silver layer is applied by combined extrusion, roll plating, or in the process of sintering the contact material. The solder layer is produced by plating or liquid soldering. The soldering is effected by hard soldering at temperatures above 600° C.

The disadvantages of the manufacturing methods known from the prior art for electrical switch contacts are firstly a complex process procedure and secondly the high process temperature.

### SUMMARY AND DESCRIPTION

Accordingly, it is an object of the present disclosure to provide an electrical switch contact that may be manufactured with reduced process complexity, and a method of manufacturing the electrical switch contact.

The scope of the present disclosure is defined solely by the appended claims and is not affected to any degree by the statements within this summary. The present embodiments may obviate one or more of the drawbacks or limitations in the related art.

According to the disclosure, this object is achieved by an electrical switch contact having a contact base and a contact layer including a contact material. The contact material is bonded to the contact base by arrangement of a sinterable layer between the contact material and the contact base.

The effect of this sinterable layer is that there is no longer any need to use a separate solder layer. The contact material is bonded directly to the base via a sintered layer, meaning that there are only three layers, the sinterable layer being positioned directly on the contact material or directly on the contact base. The process procedure includes applying of a layer of sinterable material between contact layer and base with subsequent sintering of the construction under pressure and at high temperature. Silver powder has been found to be a particularly advantageous sinterable material. Silver has the property of sintering even at temperatures much lower than in the case of hard soldering processes. Therefore, in the process described, bonds of very good conductivity and mechanical durability may be established at temperatures in the range between 250 and 300° C. and pressures of 0 to 30 MPa.

In a particularly advantageous configuration, it may be the case that the sinterable layer includes silver. Silver has the property of sintering even at temperatures much lower than in the case of hard soldering processes. The process temperature for the bonding of the contact material to the contact base here may be in a range of 250° C. to 500° C., or 250° C. to 300° C.

In a development of this concept, the sinterable layer may be in pulverulent form. Sintering refers to a method of producing or altering materials. It involves heating fine-grain ceramic or metallic substances under elevated pressure, although the temperatures remain below the melting temperature of the main components, such that the shape of the workpiece is conserved. This may result in shrinkage, because the particles of the starting material increase in density and pore spaces are filled. The thermal treatment a solid workpiece from a fine- or coarse-grain parent body that was formed in a preceding process act. It is only through the thermal treatment that the sintered product receives its final properties such as hardness, strength, or thermal conductivity that are required in the respective use.

In a further specific continuation of the concept, it may be the case that the sintering process is performable within a temperature range from 250 to 300° C. The temperatures used in the production process are thus much lower than in welding or hard soldering. The relatively low introduction of heat during the process leads to relatively low material softening in the base.

In a further specific continuation of the concept, it may be the case that the sintering process is performable within a pressure range from 0 to 30 MPa. The increase in pressure results in shrinkage, in which the particles of the starting material are consolidated and pore spaces are filled.

In a development of the concept, the heating in the electrical contact is to be introduced by resistance welding, induction soldering, ultrasound welding, a heated probe, hot gases, radiative heat, or a combination of these methods of introducing heat. By virtue of the new bonding technique by silver sintering methodology, it is no longer necessary to conduct hard soldering at a temperature above 600° C.

The object of the present disclosure is also achieved by a method of manufacturing an electrical switch contact having a contact base and a contact layer including a contact material, wherein the contact material is bonded to the contact base via a sinterable layer between the contact material and the contact base. A separate solder layer is thus no longer required. The contact material is bonded to the base via a sintered layer, (e.g., a silver layer). The process procedure includes applying a layer of sinterable material between contact layer and base with subsequent sintering of the construction under pressure and at high temperature.

It has been found here to be advantageous that the heating in the electrical switch contact is conducted by resistance welding, induction soldering, ultrasound welding, a heated probe, hot gases, radiative heat, or a combination of these methods of introducing heat.

In a development of this concept, the sintering process may be conducted within a temperature range from 250 to 300° C. This temperature range is well below the temperatures that are attained in hard soldering.

In the method, the sintering process may also be conducted within a pressure range from 0 to 30 MPa.

Moreover, it is in accordance with a continuation of the concept when the electrical switch contacts described by the above method find use in a switching device, e.g., a contactor or a circuit breaker.

The electrical switch contact has a contact base and a contact layer, wherein the contact layer includes a contact material separated from the contact base by a sinterable layer, (e.g., a silver layer). The sinterable layer is thus arranged between the contact material and the contact base. The customary solder layer between the contact base and a silver layer is thus dispensed with.

The electrical switch contact features a simplified layer construction because the solder layer is no longer required. This reduces the process sequence in that the applying of the sinterable layer may also be utilized simultaneously as a bonding process with the base. It is also advantageous that the amount of silver used overall may be decreased by reduction of the layer thicknesses. The process may proceed at much lower temperatures than in the case of welding or hard soldering. The lower input of heat into the component leads to lower material softening of the base. The bonding layer additionally has higher electrical conductivity than a comparable solder layer. A final additional factor is that the process of cleaning the parts after the bonding process is reduced.

### BRIEF DESCRIPTION OF THE DRAWINGS

Further advantages and embodiments of the disclosure are elucidated in detail hereinafter with reference to a working example and with reference to the drawings.

FIG. 1 a perspective view of an example of an electrical switch contact.

FIG. 2 a schematic diagram of the construction of an electrical switch contact from the prior art.

FIG. 3 a schematic diagram of the construction of an example of an electrical switch contact.

FIG. 4 a schematic diagram of an example of the sintering process for an electrical switch contact.

FIG. 5 a schematic diagram of an example of direct resistance heating by current flow in the electrical switch contact.

FIG. 6 a schematic diagram of an example of indirect resistance heating by current flow in the electrical switch contact.

FIG. 7 a schematic diagram of an example of inductive heating by current flow in the electrical switch contact.

### DETAILED DESCRIPTION

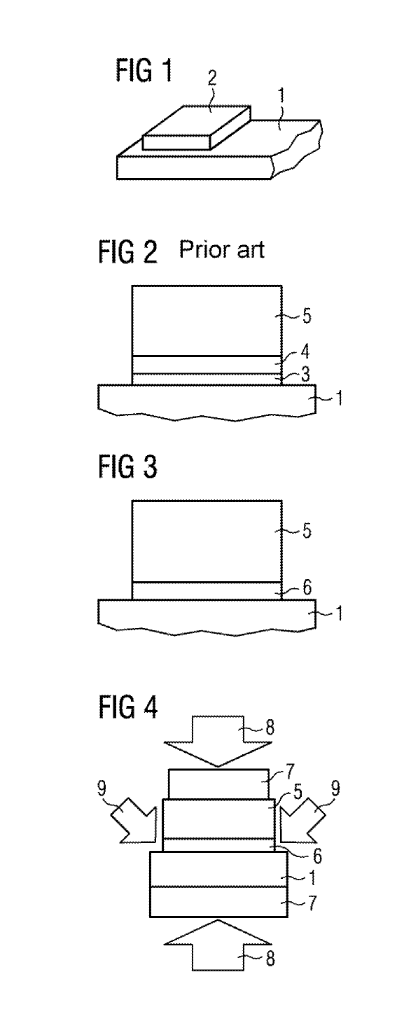

FIG. 1 depicts an electrical switch contact with a contact base 1, on the top side of which is arranged a contact layer 2.

FIG. 2 depicts the construction of an electrical switch contact from the prior art. This contact base 1 is formed from a contact base material. The contact layer 2 includes three layers, a silver solder layer 3, a silver layer 4, and a layer of contact material 5. The silver solder layer 3 here is formed directly on the top side of the contact base 1. Atop the silver solder layer 3 is formed the silver layer 4, atop which is finally applied the contact material 5.

FIG. 3 depicts the construction of an electrical switch contact. Between the contact base 1 and the contact material 5 is arranged a sinterable layer 6 on the top side of the contact base 1. The sinterable layer 6 may be a pulverulent silver layer.

FIG. 4 depicts the sintering method for an electrical switch contact. The contact base 1 including the contact layer 2, composed of the sinterable layer 6 and the contact material 5, are positioned between two tools 7 which press from the top and from the bottom by pressure 8 onto the component composed of contact base 1 and contact layer 2. In addition, heat 9 is introduced into the component, for example in the form of a probe.

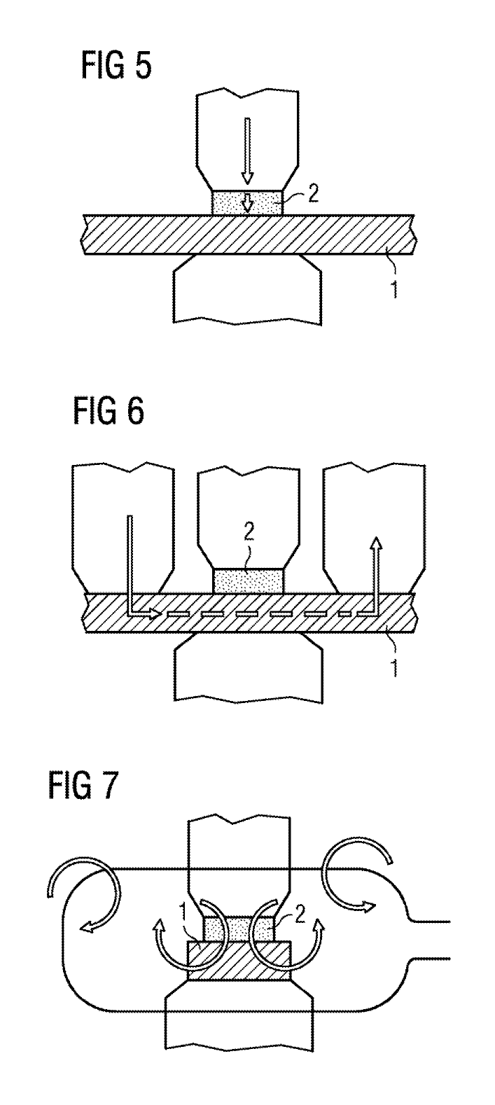

FIG. 5 depicts direct resistance heating by current flow in the electrical contact. In the direct resistance heating, the current flows directly through the component composed of a contact base 1 and a contact layer 2.

FIG. 6 depicts indirect resistance heating, in which the current flows indirectly through the component composed of contact base 1 and the contact layer 2.

FIG. 7 depicts inductive heating by a magnetic field in the contact base 1 and the contact layer 2.

The electrical switch contact features a simplified layer construction because the solder layer is no longer required. This reduces the process sequence in that the applying of the sinterable layer may also be utilized simultaneously as a bonding process with the base. It is also advantageous that the amount of silver used overall may be decreased by reduction of the layer thicknesses. The process may proceed at much lower temperatures than in the case of welding or hard soldering. The lower input of heat into the component leads to lower material softening of the base. The bonding layer additionally has higher electrical conductivity than a comparable solder layer. A final additional factor is that the process of cleaning the parts after the bonding process is reduced.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. An electrical switch contact comprising:
a contact base; and
a contact layer having a contact material,
wherein the contact material is bonded to the contact base by arrangement of a sinterable layer between the contact material and the contact base.

2. The electrical switch contact of claim 1, wherein the sinterable layer comprises silver.

3. The electrical switch contact of claim 2, wherein the sinterable layer is in pulverulent form.

4. The electrical switch contact of claim 3, wherein the contact material is sintered to the contact base within a temperature range from 250° C. to 300° C.

5. The electrical switch contact of claim 4, wherein the contact material is sintered to the contact base within a pressure range from 0 MPa to 30 MPa.

6. The electrical switch contact of claim 5, wherein a heating in the electrical switch contact is configured to be introduced by resistance welding, induction soldering, ultrasound welding, a heated probe, hot gases, radiative heat, or a combination thereof.

7. A method of manufacturing an electrical switch contact, the method comprising:
providing a contact base and a contact layer having a contact material;
applying a sinterable layer between the contact material of the contact layer and the contact base; and
sintering the contact base to the contact layer via the sinterable layer.

8. The method of claim 7, wherein the electrical switch contact is heated by resistance welding, induction soldering, ultrasound welding, a heated probe, hot gases, radiative heat, or a combination thereof.

9. The method of claim 8, wherein the sintering is conducted within a temperature range from 250° C. to 300° C.

10. The method of claim 9, wherein the sintering is conducted within a pressure range from 0 MPa to 30 MPa.

11. (canceled)

12. The electrical switch contact of claim 1, wherein the sinterable layer is in pulverulent form.

13. The electrical switch contact of claim 1, wherein the contact material is sintered to the contact base within a temperature range from 250° C. to 300° C.

14. The electrical switch contact of claim 1, wherein the contact material is sintered to the contact base within a pressure range from 0 MPa to 30 MPa.

15. The electrical switch contact of claim 1, wherein a heating in the electrical switch contact is configured to be introduced by resistance welding, induction soldering, ultrasound welding, a heated probe, hot gases, radiative heat, or a combination thereof.

16. The method of claim 7, wherein the sintering is conducted within a temperature range from 250° C. to 300° C.

17. The method of claim 7, wherein the sintering is conducted within a pressure range from 0 MPa to 30 MPa.
